(19) United States
(12) Patent Application Publication
(10) Pub. No.: US 2015/0101768 A1
(43) Pub. Date: Apr. 16, 2015

(54) Vehicle Window Sunshade

(71) Applicant: Wing Lee, San Dimas, CA (US)

(72) Inventor: Wing Lee, San Dimas, CA (US)

(21) Appl. No.: 14/051,317

(22) Filed: Oct. 10, 2013

(51) Int. Cl. B60J 1/20

(52) U.S. Cl. CPC B60J 1/2091
USPC 160/370.21

(57) ABSTRACT

A vehicle window sunshade for protecting against the harmful effects of heat and radiation from the sun. The sunshade comprises a collapsible sheet formed from a flexible material which includes a plurality of superimposed layers. The plurality of superimposed layers comprises a top layer of polyvinyl chloride (PVC) material, an inner layer of polyester film and a bottom layer made of clothing material. The top layer is flexible and adaptable to absorb/reflect the heat and radiation from sun. The inner layer is adaptable to keep air inside a vehicle to provide a fluffy feel for thermal purposes. The bottom layer is disposed with perforations to provide ventilation and breathability. The sunshade includes a plurality of suction cups and a plurality of rings to attach to and detach from a vehicle's window. In the preferred embodiment, the sunshade is custom manufactured to fit all windows for a variety of vehicle models.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This embodiment relates to sunshades, and more particularly to a vehicle window sunshade that is designed to protect against the harmful effects of heat and radiation from sun.

### DISCUSSION OF RELATED ART

Due to the increase in use of vehicles, there is a shortage of covered parking lots and so vehicles, particularly cars, have been parked in places exposed to direct sunlight. The problem that is faced by car users is an extremely hot interior after a certain amount of time parking in the open or un-shaded parking area. Solar radiation enters the car through the windshield and is trapped within the car. The trapped heat causes the car cabin and interior temperature to rise significantly above the ambient temperature. The accumulation of thermal energy inside the vehicle with undesired temperature rise can cause the interior parts to degrade and shortens the life span of the various components inside the car. Passengers are also affected by the thermal condition inside the vehicle. The car user is forced to wait for a period of time before getting into the car to cool down the interior of car either by rolling down the windows or running the air conditioner at high speed which has a negative impact on fuel consumption.

To prevent hot sunshine/radiation from directly passing through car windows, there are various types of car blinds, window films, sun guards or sunshades commercially available on the market. A difficulty with all these devices has been they are not custom manufactured to fit all windows for a variety of cars models.

Certain sunshades are made of cardboard and are folded in a panel shape. Such sunshades require a lot of storage room when the sunshades are not in use. Such sunshades are bulky, cumbersome and are not lightweight and aerated. Most of the conventional sunshades are made for use only on the windshield. This allows the vehicle user to block a portion of the sun from entering the vehicle, but cannot block the sun from entering the other vehicle windows.

Some sunshades include Velcro pads to attach the sunshade to the windows of vehicle. Such sunshades can cause scratching or damage to the glass due to the use of Velcro pads while removing the sunshades. Such sunshades also require additional adhesive removal spray for pulling the sunshade or cleaning the remaining adhesives from the window glass.

Some sunshades are custom made for specific car models, and for all windows of the car. However, even these sun shades are attached to the window glass to block sunshine They cannot reflect/absorb the radiations completely and are not heat-insulation effective.

In light of the foregoing, there is a need for an economical, simple vehicle window sunshade that can be easily configured to use with all vehicle windows regardless of the vehicle model. Such a needed shade would include a plurality of superimposed layers to completely absorb/reflect the sun's radiation and heat to provide effective heat insulation, and to provide breathability. Moreover, this vehicle window sunshade would include a plurality of suction cups and a plurality of rings to attach to and detach from a vehicle's window without causing any damage to the window glass. Further, the present embodiment would be relatively quick and easy to install, and to collapse or fold/roll into a shape or configuration which would be stored safely and compactly in a carrier bag inside the vehicle. The present embodiment accomplishes these objectives.

### SUMMARY OF THE DISCLOSURE

The present embodiment is a vehicle window sunshade for protecting against the harmful effects of heat and radiations from sun. In the embodiment illustrated, the vehicle window sunshade comprises a collapsible sheet formed from a flexible material, the flexible material includes a plurality of superimposed or laminated layers. The plurality of superimposed layers comprises a top layer of polyvinyl chloride (PVC) material, an inner layer of polyester film and a bottom layer made of clothing material. The top layer of polyvinyl chloride (PVC) material is laminated or otherwise superimposed further with the inner layer of polyester film and again laminated or attached with the bottom layer. Moreover, the top layer of polyvinyl chloride (PVC) material, the inner layer of polyester film and the bottom layer can be made from variety of materials for blocking sun and providing comfort.

The top layer of polyvinyl chloride (PVC) material includes hump-like indentations which provide sufficient protection against the passage of wind-blown rain and other moisture. The top layer of polyvinyl chloride (PVC) material is flexible and adaptable to absorb/reflect the heat and radiation from sun. The inner layer of polyester film is adaptable to keep air inside a vehicle to provide a fluffy feel for thermal purposes. The bottom layer is disposed with a plurality of perforations to provide ventilation and breathability.

The top layer polyvinyl chloride (PVC) material is disposed with a plurality of suction cups to hold the vehicle window sunshade against a window of a vehicle. Preferably, the plurality of suction cups is made of rubber. The bottom layer is disposed with a plurality of rings, each ring arranged or pinned behind each suction cup. The vehicle window sunshade is attached to glass of the window of the vehicle utilizing the plurality of suction cups. The plurality of rings allows a user to pull or easily remove the plurality of suction cups from the window of the vehicle when not in use. Preferably, the plurality of rings is made of metal.

In one embodiment, the vehicle window sunshade is made of a flexible material which allows wrapping the vehicle window sunshade into a roll. The vehicle window sunshade can be rolled/folded and stored in a carrier bag or dispenser container when not in use.

The present embodiment provides an economical, simple vehicle window sunshade that can be easily configured to use with all vehicle windows regardless of the vehicle model. Such a needed shade would include a plurality of superimposed layers to completely absorb/reflect the sun's radiation and heat to provide effective heat insulation, and to provide breathability. Moreover, this vehicle window sunshade would include a plurality of suction cups and a plurality of rings to attach to and detach from a vehicle's window without causing any damage to the window glass. Further, the present embodiment would be relatively quick and easy to install, and to collapse or fold/roll into a shape or configuration which would be stored safely and compactly in a carrier bag inside the vehicle. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a top perspective view of a vehicle window sunshade in accordance with a preferred embodiment of the present invention;

FIG. 2 is a bottom plan view of the vehicle window sunshade shown in FIG. 1;

FIG. 3 is a cross-sectional, blow up view of the vehicle window sunshade shown in FIG. 1;

FIG. 4 is a side perspective view of a vehicle window sunshade in accordance with a preferred embodiment of the present invention; and

FIG. 5 is a perspective view of the vehicle window sunshade when in use.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

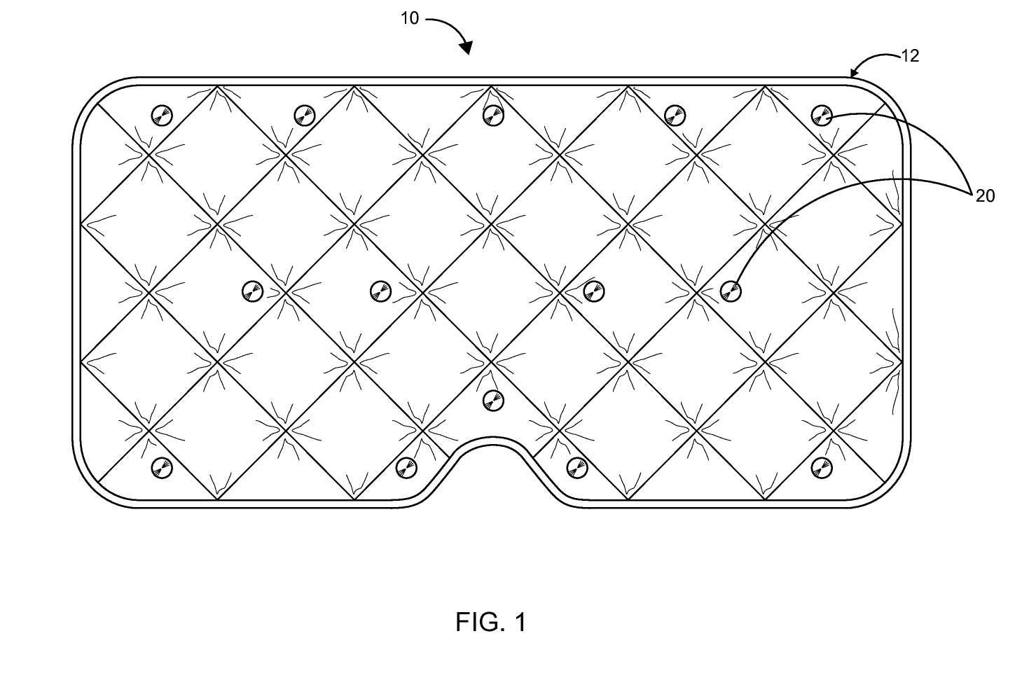

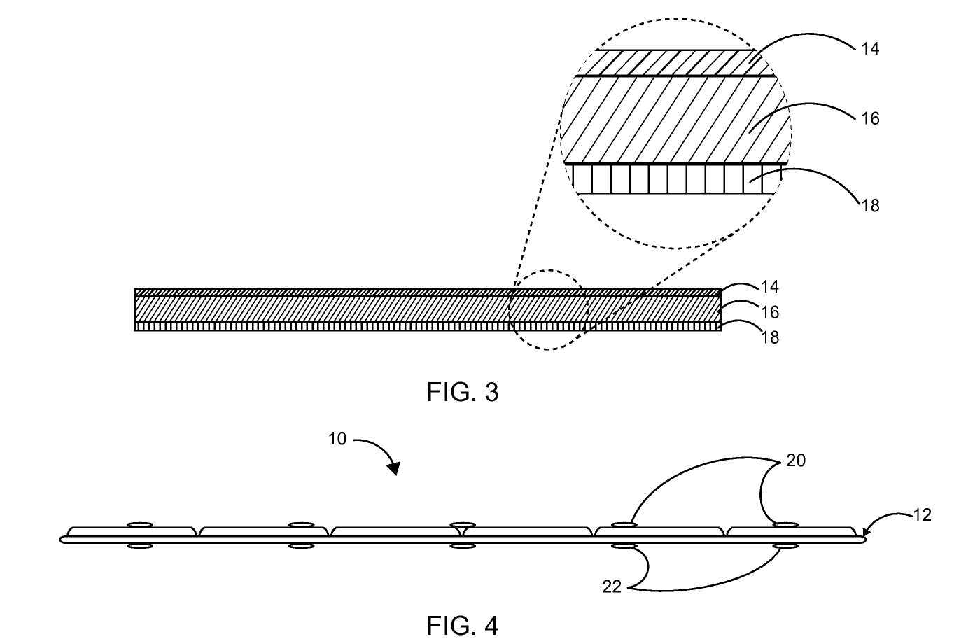

Referring to FIGS. 1, 2, 3 and 4, different views of a vehicle window sunshade 10 for protecting against the harmful effects of heat and radiation from sun in accordance with a preferred embodiment of the present invention are illustrated. In the embodiment illustrated, the vehicle window sunshade 10 comprises a collapsible sheet 12 formed from a flexible material, the flexible material includes a plurality of superimposed or laminated layers. The plurality of superimposed layers comprises a top layer of polyvinyl chloride (PVC) material 14, an inner layer of polyester film 16 and a bottom layer of clothing material 18. As shown in FIG. 3, the top layer of polyvinyl chloride (PVC) material 14 is laminated or otherwise superimposed further with the inner layer of polyester film 16 and again laminated or attached with the bottom layer 18 made of clothing material. Moreover, the top layer of polyvinyl chloride (PVC) material 14, the inner layer of polyester film 16 and the bottom layer 18 can be made from variety of materials for blocking sun and providing comfort.

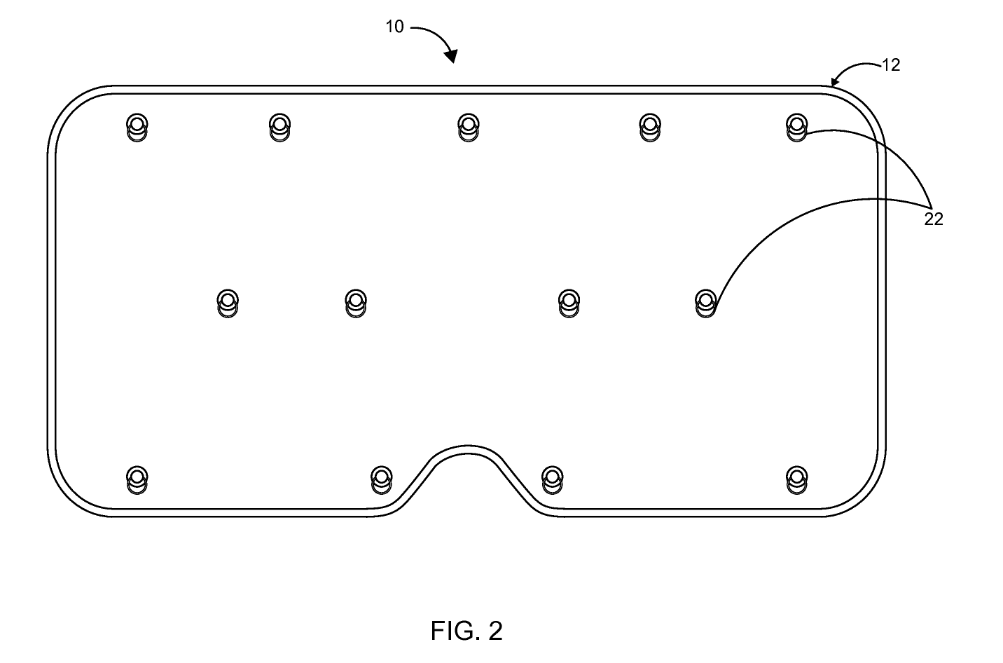

The top layer of polyvinyl chloride (PVC) material 14 is flexible and adaptable to absorb/reflect the heat and radiation from sun. The inner layer of polyester film 16 is adaptable to keep air inside a vehicle to provide a fluffy feel for thermal purposes. The bottom layer 18 is disposed with a plurality of perforations 28 to provide ventilation and breathability. The top layer of polyvinyl chloride (PVC) material 14 is disposed with a plurality of suction cups 20 to hold the vehicle window sunshade 10 to any surface and the bottom layer 18 is disposed with a plurality of rings 22 (See FIG. 2) to pull the plurality of suction cups 20 from the surface. Each ring 22 is arranged or pinned behind each suction cup 20 (See FIG. 4). FIG. 4 shows hump-like indentations on the top layer of polyvinyl chloride (PVC) material. The hump-like indentations provide sufficient protection against the passage of wind-blown rain and other moisture.

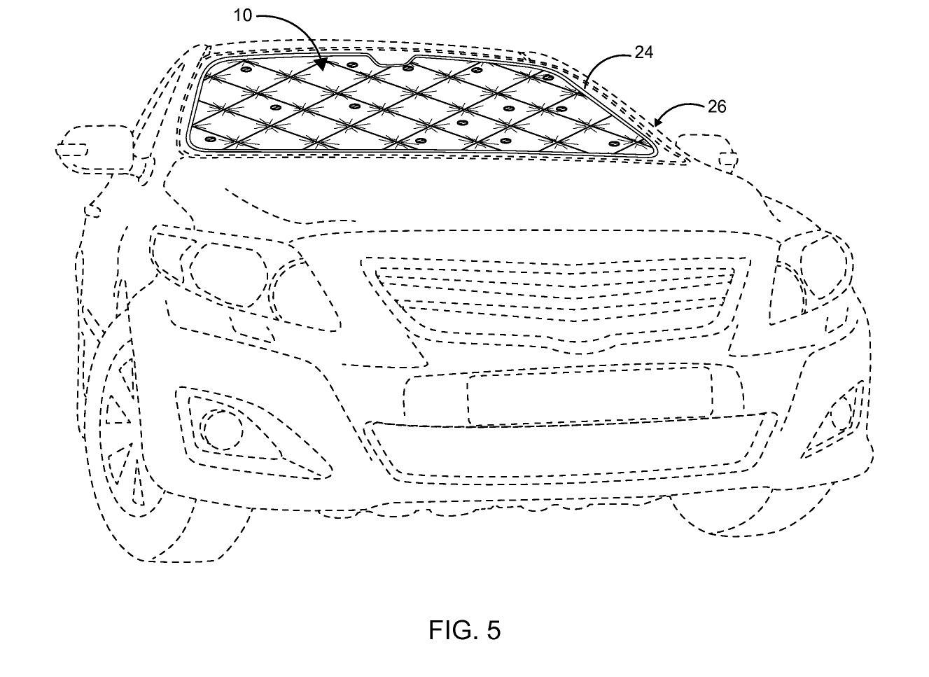

The plurality of suction cups 20 disposed in the top layer polyvinyl chloride (PVC) material 14 holds the vehicle window sunshade 10 against a window 24 of a vehicle 26 (See FIG. 5). Preferably, the plurality of suction cups 20 is made of rubber. The plurality of rings 22 disposed in the bottom layer 18 allows a user to pull or easily remove the plurality of suction cups 20 from the window 24 of the vehicle 26 when not in use. Preferably, the plurality of rings 22 is made of metal.

Referring to FIG. 5, a perspective view of the vehicle window sunshade 10 when in use is illustrated. In this example, the vehicle window sunshade 10 is attached to glass of the window 24 of the vehicle 26 utilizing the plurality of suction cups 20 when the vehicle 26 is parked under an open or un-shaded parking area. Preferably, the vehicle window sunshade 10 is adapted to be attached onto a land-based motor-driven vehicle. Preferably, the motor-driven vehicle is a car. The user can detach the vehicle window sunshade 10 by pulling the plurality of metal rings 22 by easily removing the plurality of suction cups 20 from the window 24 of the vehicle 26 when not in use.

The vehicle window sunshade 10 can be used for all vehicle windows by varying the shape and/or size of the collapsible sheet 12 to accommodate a variety of car models. For instance, the location, shape and size of the plurality of suction cups 20 and the plurality of metal rings 22 can be customized to accommodate different car models. For example, the vehicle window sunshade 10 can be made in different sizes, such as small, medium, and large, not limited to those shown in the figures.

In one embodiment, the vehicle window sunshade 10 can be rolled/folded and stored in a carrier bag or dispenser container when not in use. The rolled vehicle window sunshade stored in the carrier bag provides easy storage inside vehicles, dispensing, shipping and protection. The vehicle window sunshade 10 is made of flexible material which allows wrapping the vehicle window sunshade 10 into a roll. The size of the rolled vehicle window sunshade stored in the carrier bag is about the size of a sleeping pillow.

While a particular form of the invention has been illustrated and described, it will be apparent that various modifications can be made without departing from the spirit and scope of the invention. For example, the vehicle window sunshade 10 may be made of different materials or layers that provide more heat insulation and customized to fit all windows of different vehicle models. Accordingly, it is not intended that the invention be limited, except as by the appended claims.

What is claimed is:

1. A vehicle window sunshade for protecting against the harmful effects of heat and radiation from sun, formed from a flexible material, the flexible material consisting of a plurality of superimposed layers of different materials, the plurality of superimposed layers having a top layer of polyvinyl chloride (PVC) material being flexible and adaptable to absorb and reflect the heat and radiation and an inner layer of polyester film being adaptable to keep air inside to provide a fluffy feel for thermal purposes, and a bottom layer of clothing material being disposed with a plurality of perforations to provide ventilation;
whereby the vehicle window sunshade is custom designed to fit all windows for a variety of vehicle models and protect against the harmful effects of heat and radiation from the sun.

2. The vehicle window sunshade of claim 1 wherein the top layer of PVC includes a plurality of suction cups that is adaptable to hold the vehicle window sunshade against the window of the vehicle.

3. The vehicle window sunshade of claim 2 wherein the bottom layer of clothing material includes a plurality of rings that is adaptable to easily remove the plurality of suction cups from the window of the vehicle.

4. The vehicle window sunshade of claim 1 wherein the plurality of suction cups is made of rubber.

5. (canceled)

6. The vehicle window sunshade of claim 1 is configured to roll and fold and is stored in a carrier bag when not in use.

7. A vehicle window sunshade comprising:
a collapsible sheet being formed from a flexible material, the flexible material consisting of a plurality of superimposed layers having a top layer of polyvinyl chloride (PVC) material and an inner layer of polyester film, and a bottom layer of clothing material, a plurality of suction cups disposed on the top layer of PVC, and a plurality of rings on the bottom layer, each ring being pinned arranged behind each suction cup;
whereby the vehicle window sunshade is custom designed to fit all windows for a variety of vehicle models and protect against the harmful effects of heat and radiation from the sun.

8. The vehicle window sunshade of claim 7 wherein the plurality of suction cups is adaptable to hold the vehicle window sunshade against the window of the vehicle.

9. The vehicle window sunshade of claim 7 wherein the plurality of rings is adaptable to easily remove the suction cup from the window of the vehicle.

10. The vehicle window sunshade of claim 7 wherein the plurality of suction cups is made of rubber.

11. (canceled)

12. The vehicle window sunshade of claim 7 wherein the top layer of PVC is flexible to absorb and reflect the heat and radiation from the sun.

13. (canceled)

14. The vehicle window sunshade of claim 7 wherein the bottom layer of clothing material includes a plurality of perforations to provide ventilation.

15. A vehicle window sunshade adaptable to protect against the harmful effects of heat and radiation from the sun, the vehicle window sunshade comprising:
a collapsible sheet being formed from a flexible material, the flexible material consisting of a plurality of superimposed layers, the plurality of superimposed layers comprising:
a top layer of polyvinyl chloride (PVC) material having a plurality of suction cups, the top layer of PVC material being flexible and adaptable to absorb and reflect the heat and radiation from sun;
an inner layer of polyester film being adaptable to keep air inside a vehicle to provide a fluffy feel for thermal purposes; and
a bottom layer of clothing material having a plurality of rings, each ring being pinned arranged behind each suction cup, the bottom layer of clothing material being disposed with a plurality of perforations to provide ventilation;
whereby the vehicle window sunshade is custom designed to fit all windows for a variety of vehicle models and protect against the harmful effects of heat and radiation from the sun.

16. The vehicle window sunshade of claim 15 wherein the plurality of suction cups is adaptable to hold the vehicle window sunshade against the window of the vehicle.

17. The vehicle window sunshade of claim 15 wherein the plurality of rings is adaptable to easily remove the suction cup from the window of the vehicle.

18. The vehicle window sunshade of claim 15 wherein the plurality of suction cups is made of rubber.

19. (canceled)

20. The vehicle window sunshade of claim 15 is configured to roll and fold and is stored in a carrier bag when not in use.
